(19) United States
(12) Patent Application Publication
(10) Pub. No.: US 2006/0168015 A1
(43) Pub. Date: Jul. 27, 2006

(54) Instant messenger as a web-based communicator

(76) Inventor: Brian Fowler, Sunrise, FL (US)

Correspondence Address: FRIED, FRANK, HARRIS, SHRIVER & JACOBSON, 1001 PENNSYLVANIA AVE., N.W., SUITE 800, WASHINGTON, DC, 20004-2505, US

(21) Appl. No.: 10/999,872

(22) Filed: Nov. 30, 2004

(51) Int. Cl. G06F 15/16

(52) U.S. Cl. 709/206; 709/204

(57) ABSTRACT

A plug-in for use with an instant messenger utility that enables users to make telephone calls through the instant messenger. The plug-in provides users of web-based IM clients, an interface to call contact in their contact list. The plug-in also acts as a connector between users of disparate networks, allowing users of one IM network to communicate with users of another IM network. The plug-in can also call-enable other web-based applications.

### BACKGROUND OF THE INVENTION

The present invention relates generally to the field of instant messaging. More particularly, the present invention enables users, through their instant messaging utility, to place and receive calls over a packet-based network.

In the early 1990s, people began to spend an increasing amount of time on the Internet. For many, e-mail began to replace sending letters and to some extent, making telephone calls. However, e-mail had numerous drawbacks: users had no way of knowing whether the e-mail recipient was online at the particular moment the e-mail was sent, thus no way of knowing whether the e-mail had been received and read by the recipient; if two people were e-mailing back and forth they would have to spend valuable time clicking through steps to read, reply and send messages. Largely because of these inherent limitations of e-mail, one of the more popular innovations that resulted from this increased interest in and use of the Internet is instant messaging. Instant messaging, or IM, is a text-based tool that allows users to carry on conversations when connected to the Internet. Users typically subscribe with a particular IM service provider, for example AOL offers an instant messenger, AIM. Instant messaging users maintain a list of people with whom they wish to interact. Users receive notification of who on their contact list is online at any given time and can quickly send messages to any of the people on their list of contacts, or contact lists, so long as that person is online.

Instant messaging first began to gain widespread popularity with the introduction of ICQ, short for “I seek you,” in November 1996 by Mirabilis Ltd., an Israeli company. ICQ is an instant messaging utility that allows users to communicate in real time. The debut of ICQ was quickly followed by the introduction of instant messaging services operated by such industry leaders as Microsoft, AOL and Yahoo. Each of these IM services operates in the same basic way: Users obtain the instant messaging software client and download the software to their computers. Once the software is installed, users can open the client and connect to the server of the particular service provider. Once the client connects to the server, users log on to the server, usually using a name and password established during a registration process. The client sends identifying connection information to the server, including the IP address and port number assigned to the client. The client also provides the server with all of the user names in the user's contact list. The server then creates a temporary file with the user's connection information and contact list. Using the contact list, the server determines whether any of the people listed on the user's contact list are logged in to the service. The server notifies the user by sending a message to the client if it determines that people on her contact list are logged on to the service. Similarly, the server sends a notification message to people on the user's contact list that the user is logged on. The user can click on the name of a person in the contact list who is online and a window opens that the user can enter a text message into. Once the message has been entered into the window, the user clicks a send button and the message is sent to the contact. Messages may then be exchanged in this manner between the parties until the parties decide to end their “conversation.”

Instant messaging offers many other features in addition to being able to quickly send text messages between parties. For example, instant messaging software has been used in voice communications by several companies. Net2Phone has collaborated with Microsoft and AOL to provide VoIP service through the instant messenger service by integrating its voice software into each of the companies' instant messenger services, but not for use across those types of services; Sylantro Systems Corporation has collaborated with Yahoo to integrate VoIP services with Yahoo's Instant Messenger, allowing users of that IM service to place VoIP calls through that service to other users of that type of service. Instant messaging programs also allow users to exchange links to websites, share files by sending them directly to people on the user's contact list, and many other features.

While instant messaging has garnered many fans due to the ease of real time communication between users, one of the major drawbacks of the different types of instant messaging networks has been that users of one type of instant messaging system are only able to communicate with other members of the same type of instant messaging community. For example, user X uses the Microsoft Instant Messenger to communicate with her family. User X's sister, Y, is a member of the Yahoo instant messaging community. In order for X and Y to instant message one another, either X must join the Yahoo instant messaging community, or Y would have to join Microsoft's instant messaging community. Users of different types of instant messaging networks are generally not able to communicate with each other using instant messaging because each of the IM networks uses its own proprietary protocol. This lack of interoperability remains one of the biggest problems in instant messaging today, and this lack of interoperability carries over to the VoIP services offered through the different proprietary instant messaging services.

### BRIEF SUMMARY OF THE INVENTION

The present invention is an overlay to web-based instant messaging applications. It enables users to place and receive calls through an instant messenger over a packet-based network like the Internet. The technology involved is an additional application that, when running, offers users of web-based IM clients, such as the MSN Web Messenger, an independent interface to call individuals in their contact lists. Additionally, the invention acts as “connector” to a variety of web-based applications allowing users of disparate networks to interact with each other.

### BRIEF DESCRIPTION OF THE DRAWINGS

FIG. 1 is a screen shot depicting the user interface menu of the preferred embodiment of the present invention.

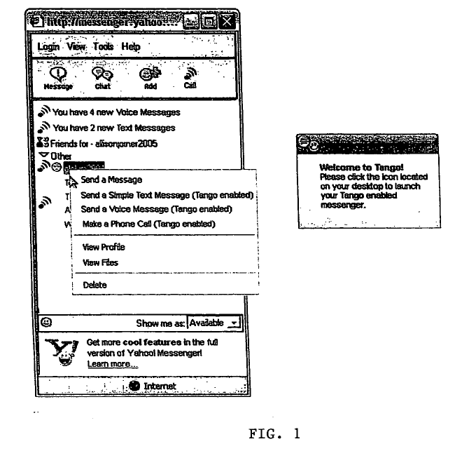

FIG. 2 is a screen shot depicting the user interface of a plug-in enabled instant messenger's contact list in accordance with the present invention.

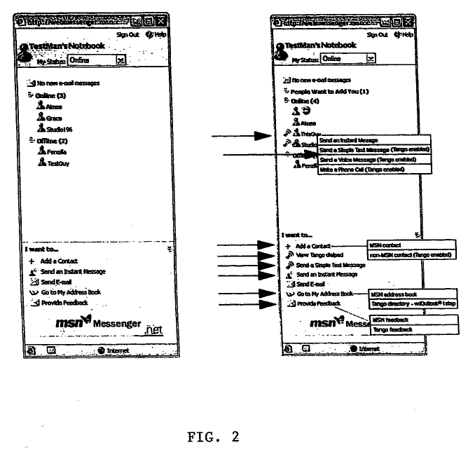

### DETAILED DESCRIPTION OF THE INVENTION

The present invention simplifies the provisioning of IP telephony services by integrating a modular software application (a “plug-in”) for utilizing IP telephony services with one or more presently available instant messengers. The system enables users to place and receive calls directly from their instant messengers on their computers to other IM users as well as outside the IM Network. This plug-in therefore also acts as a connector for disparate IM networks, overcoming the interoperability problems present between the different IM networks. Each of the popular instant messengers currently available use their own proprietary protocols, thus users of one messenger, for example Microsoft Messenger, are not able to communicate with persons who use the AOL Instant Messenger. Using the present example, the plug-in is able to overcome the interoperability issues between such IM networks so as to allow users of Microsoft Messenger to communicate with users of the AOL Instant Messenger. This is possible because after the plug-in is downloaded by both parties, those parties are instantly able to use the new functionality of the plug-in, which is overlayed onto their IM product, as a common communication platform between the parties. The plug-in becomes the connection in common between the users who can now communicate with one another while never leaving their MSN or AOL experiences.

The overlay does not alter the normal operation of the instant messenger's static user interface. The only alteration is a dynamic drop-down menu that appears as an overlay when users click on contact names in their instant messenger contact list. The menu provides users with two options: message and call. If the user selects call, a request is sent to a database for name and number resolution. Once a number is obtained for that contact, the plug-in or helper application, attempts to connect to that number for real time voice communications. The perception to the customer receiving a call would be the same as if someone had sent them an instant message. Instead of a text message interface, however, the user is presented with a dialpad as an interface to the incoming call. The user's overall instant messenger experience does not change.

The plug-in runs on the user's personal computer. The application loads the user's preferred web-based IM application for preprocessing. After authentication with the preferred IM network the preprocessing engine adds extra functionality to the web messenger before it gets processed. In a web-based environment, the preferred embodiment of the present invention, this means adding specific events and functions to the messenger's source code before it gets compiled and processed by the web-browser. A primary event and function would include the event of a click on a screen name from the user's contact list, which would call a function; the function associated with that event would send a query string, for example, http://www.glophone.com/dialpad.asp?scname=XYZ@voiceglo.com, for telephone number resolution, were XYZ@voiceglo.com is the screen name. Upon resolution of the screen name the user is redirected to a dialto://URL with the appropriate telephone number, such as dialto://95411122233344. An Internet phone call is then setup in the typically known manner for real time voice communications. The same process is utilized for all services, whether text messaging or voice messaging.

The setup procedure for using the calling feature requires users to register for a telephone number using the same e-mail address as their web messenger contact address. Users may alternatively select a telephone number or have one assigned to them. This telephone number rings directly to their desktops from over two hundred rate centers in the U.S. Users would also be required to provide additional identification information such as their names. Once registered, the e-mail address provided by the user is mapped to the selected telephone number for resolution purposes. The helper application does not utilize a VoIP protocol, but has the intelligence to direct calls destined for a VoIP network to a VoIP engine for signaling and call setup.

The instant messenger plug-in has the ability to allow an entire IM network to communicate using voice in real time without any modification to the instant messenger client. The IM plug-in utilizes an URL protocol that enables it, as with any web-based application, to interface with a VoIP engine and an Internet network. IM users placing IM-to-IM calls could do so for free under one embodiment, on a pay by call basis, or pay some overhead fee for the right to place such calls for no further charge. Only calls that require utilization of a telephony based network, such as the public switched network or other proprietary networks, might require a fee. All addressing and signaling for call setup and tear down would be handled by the VoIP network, so there would be no modifications required on the backend network for the IM service provider.

The IM plug-in is a logical entity that receives requests as a user agent server (“UAS”) and, in order to respond to them, acts as a user agent client (“UAC”) and generates requests. Additionally, it maintains a dialog state and must participate in all of the requests sent on the dialogs it has established.

To utilize the plug-in, the user would also require a VoIP engine, which is another software application that could be installed with the plug-in, or which is commonly available on users computers as original equipment or readily accessible over the Internet. The VoIP engine is positioned between the IM plug-in application subsystem and an external VoIP network. It handles all VoIP signaling and session attempts. The originating IM plug-in client application routes signaling messages through the VoIP engine when the destination network is telephony-based.

To become a member of the IM-plug-in community, a user would first subscribe to one of the existing IM Networks such as AIM, Yahoo, MSN or ICQ, as their home IM network. A user would then subscribe to the IM plug-in from a web-based registration form. Registration would elicit information from the subscriber such as a user identification (E-mail address) from the home IM network and the user's first and last name.

To insure the integrity of the IM plug-in community database, the user's data is passed (in either real-time or via batch) to an opt-in mail system such as SendTec's Double Opt In Mail System. The opt-in mail system will store the user's personal information in a database and assign a unique ID for that user. As soon as the opt-in mail system receives the data, it will send out an e-mail message to the e-mail address provided by the user during registration. Within the e-mail sent by the opt-in mail system, a link will be provided so that the user can continue to acquire the required tools, such as the VoIP engine, to become a member. This link will also contain, within the query string, the opt-in mail system, such that the user click's on the link and confirms that the user's e-mail address is valid.

The confirmed user is routed to a landing page that is hosted by the opt-in mail system. On this page the user is asked to select an area code that is mapped by the opt-in mail system provisioning system to their home IM User ID, which is the user's IM account. The opt-in mail system's servers will submit all of the information about the user, based on the unique ID, to one or more VoIP servers for provisioning. During this process, the opt-in mail system will also either generate or ask the user for a password for the user, and pass that along during the provisioning process. VoIP servers will then return a selected phone number (as previously discussed), the “parent” number, for the user. The system has the flexibility to assign numbers or allow a user to select a number. In one embodiment of the present invention, free users would be assigned a telephone number and paying users would have the option to select a telephone number. As an added feature, users could also chose to register a friend at the same time and receive reduced rates for calls through the IM to their friend. Under such circumstances, the double opt-in system would make another connection to the VoIP servers and pass the friend's e-mail and area code along with the newly received parent phone number.

Registration is then completed by routing the user to an activation website. On the activation website, the user is taken to a confirmation page. On this page the user's phone number and password is displayed to them. Also on this page, an IMG tag is placed that calls a script from the same server from which the activation confirmation page is served. The IMG tag passes the user's sign-up data to another domain that causes a cookie to be set on the user's computer for auto activation. The cookie includes the user's new phone number and password. While on the confirmation page, the download of the plug-in will automatically be called after a short delay.

Once the download is started, an additional activation challenge form will pop up as a window on the user's screen. Another IMG tag will be placed on this HTML page. This tag is a script that reads the cookie and then populates the phone number and password in the activation challenge form. If the user did not accept the original cookie, then the user will have to manually enter in their phone number and password (which are still available on the confirmation page behind the installation window).

Upon activation, the plug-in download is completed and a configuration file instructs the application to pop up a default window that asks the user if they would like their current web-based IM client to be their default client for call purposes. After selecting yes or no, a notification window is generated in the lower right corner of the member's screen. The notification window alerts users to incoming calls, with Caller ID, or alerts the user to an incoming text message with Sender ID. The notification window will also display the status of a user's account and the user's service level. The notification window can be left visible or minimized to the system tray.

A floating menu system can also be used to indicate that the plug-in is running and functional. When a user clicks on a contact from the contact list, they will be presented with a floating menu. The menu display options are:
Instant Message (“IM”)
Text Message (“TM”)
Voice Message (“VM”)
Call
Refer a Friend

When the user sends a message to a friend who is using a different IM Messenger, the friend is able to read the incoming message, but in order to respond, they must also download the plug-in. When the friend clicks Respond, a message pops up on their computer screen instructing them to download the plug-in. Within that message, there will be a link to the registration landing page where the friend will receive directions to guide her through the same registration process as described above.

Once the plug-in is downloaded and the user registered, a plug-in icon is stored on the user's desktop. When a user clicks the plug-in icon on the desktop, a default instant messenger opens. A message slides up in the lower right corner welcoming the user to the plug-in. Users may then click on a name in the contact list of the plug-in-enabled web-based instant messenger. A menu opens where users can select one of four options on the contact list for contacts who are also enabled:
Send an Instant Message: Users select this option if they want to send an instant message to a contact. If users select this option, they can send instant messages as they normally have on their IM application. They can send a message in the same manner to which they have been accustomed. If a user selects to IM, the dialog box associated with their default instant messenger will be presented. In this sense, the user experience does not change.
Send a Simple Text Message: Users select this option if they want to send a simple text message to a (plug-in enabled) contact. This is similar to sending a text message from one cell phone to another. If the user selects text message (“TM”), a new pop window, with the same tree structure as the user's IM contacts is presented. The user has the option to TM one contact or all contacts.
Send a Voice Message: Users select this option to send a 5 second voice message to an enabled contact, whether or not that contact is online.
Make a Phone Call: Users select this option if they want to call the contact using their plug-in enabled instant messenger as described above.

While the present invention has been described in conjunction with specific embodiments, including a preferred embodiment, it is evident that numerous alternatives, modifications and variations will be apparent to those skilled in the art of the foregoing description. For example, while the present invention has been described for use with instant messengers, the application of the technology can be broadened to accompany the user's total web experience. One example of such a use occurs when users of the plug-in visit a website such as yellowpages.com. Users would be able to “click” on phone numbers displayed at yellowpages.com to complete calls directly from their desktops, without requiring any assistance or enabling technology from yellowpages.com. This is accomplished because the functionality described above is overlayed with any call-enabled web applications, including the browser. Accordingly, the present invention is not intended to be limited to just the described embodiments, and should be interpreted to include all such alternatives, modifications and variations.

What is claimed is:

1. A method for initiating communication over an Internet network between a first type instant messenger utility and a second type instant messenger utility, the method comprising:
receiving a request from a first user at a first terminal utilizing said first type instant messenger utility to communicate with a second user at a second terminal utilizing said second type instant messenger utility;
accessing a database over said Internet in response to said request to translate a user name associated with said second user into a contact number for said second user, said user name being linked to said first type instant messenger utility; and
utilizing said contact number for said second user to initiate communication over said Internet network with said second user at said second terminal.

2. The method of claim 1, wherein said first type instant messenger utility and said second type instant messenger utility are not compatible for either text or voice communication.

3. The method of claim 2, wherein communication includes instant messaging, text messaging, voice messaging and real-time voice.

4. The method of claim 3, wherein said contact number is a telephone number.

5. The method of claim 4, wherein said utilizing includes initiating a telephone call to said second user over said Internet network through a VoIP engine.

6. The method of claim 5, wherein said telephone number is either selected by or assigned to said second user.

7. The method of claim 2, wherein said method further comprises installing a first plug-in on said first terminal that is compatible with a second plug-in installed on said second terminal, said first plug-in being integrated with said first type instant messenger utility, said second plug-in being integrated with said second type instant messenger utility.

8. The method of claim 7, wherein communication includes instant messaging, text messaging, voice messaging and real-time voice.

9. The method of claim 7, wherein said first plug-in and said second plug-in do not alter normal alteration of said first type instant messenger utility and said second type instant messenger utility, respectively.

10. The method of claim 9, wherein said plug-in creates a drop-down menu that appears as an overlay on an interface for said first type instant messenger utility when said first user at said first terminal selects said user name.

11. The method of claim 10, wherein said user name is included in a list of user names linked to said first type instant messenger utility.

12. The method of claim 8, wherein said utilizing includes translating said contact number into a URL associated with said contact number.

13. The method of claim 12, wherein said utilizing includes initiating a telephone call to said second user over said Internet network by accessing a VOIP engine through said URL.

14. The method of claim 13, wherein said contact number is a telephone number.

15. The method of claim 7, wherein said first user refers said second user when said first user is installing said first plug-in, and wherein a cost of communication between said first user and said second user is discounted when said second user installs said second plug-in.

16. A system that allows a first user of a first type instant messenger utility on a first computer to communicate with a second user of a second type instant messenger utility, said system comprising:
said first computer connected to a computer network;
said first computer equipped with a VoIP engine;
said first computer equipped with said first type instant messenger utility;
said first type instant messenger utility including a first plug-in on said first terminal that is compatible with a second plug-in installed on a second computer utilized by said second user to operate said second type instant messenger utility, said first plug-in being integrated with said first type instant messenger utility, said first plug-in being operative to communicate with said VoIP engine when said first user identifies said second user's contact name from a list of contact names generated by said first type instant messenger utility; and
said VoIP engine being operative to establish communication with said second user through said second type instant messenger utility in response to said first user's identification of said contact name.

17. The system of claim 16, wherein first type instant messenger utility and said second type instant messenger utility are not compatible for communication.

18. The system of claim 17, wherein communication includes instant messaging, text messaging, voice messaging and real-time voice.

19. The system of claim 18, said first plug-in translates said contact name into a telephone number.

20. A method for initiating communication over an Internet network between a first software application on a first computer and a second computer, wherein said first software application does not include communication functionality compatible with said second computer, the method comprising:
integrating a plug-in with said first software application, said plug-in being capable of translating a contact ID selected through said first software application into a contact number; and
initiating communication with said second computer utilizing said contact number to drive a communication engine installed in said first computer.
